(19) United States
(12) Patent Application Publication
(10) Pub. No.: US 2003/0185222 A1
(43) Pub. Date: Oct. 2, 2003

(54) Method for the setting of a jitter buffer in a media gateway

(76) Inventor: Peter Goldstein, Thalwil (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/374,983

(22) Filed: Feb. 28, 2003

(30) Foreign Application Priority Data
Mar. 28, 2002 (EP) 02 007 139.5

(51) Int. Cl. H04L 12/28

(52) U.S. Cl. 370/401; 370/412

(57) ABSTRACT

A media gateway is disclosed in the figure, which is inserted between a line-switching network and in particular connecting network and a packet-switching network. Voice and data services in the speech tape like fax/modem connections are controlled by this media gateway. A sound detection function is proposed for the setting of the size of the jitter buffer, which carries out a setting of the jitter buffer size for each connection in direction to the line-switching network and in particular connecting network by the control, depending from the determined service. The mentioned additional sound detection function indicates a disabling sound of an echo suppressing function integrated in a media gateway in a preferred design of execution.

### BACKGROUND OF THE INVENTION

The present invention relates to a method for the setting of the jitter buffer size in a media gateway inserted between a packet switching network and a line switching network and a media gateway for the execution of the method.

The present invention concerns the area of the FAX/modem transmission in the speech tape and the telephony by the line switching network as for example PSTN and ISDN. A line switching network offers a very high service quality, particularly, the running time between the final points (=subscribers/terminals) is constant. The line operators increasingly use a packet switching network for real time processing, for example voice and/or data in the speech tape. In the following, the English system of naming from the documents ITU (International Telecommunication Union) and the IETF (Internet Engineering Task Force) is used where necessary, for clarity purposes.

A typical network configuration is depicted FIG. 1. The subscribers/terminals are connected to a line switching network and in particular connecting network 6 by a so-called backbone network 1, which is based on the internet protocol. The connection between “line-switching network” and “packet-switching network” is realized for the useful information (for example voice fax/modem) by a so-called media gateways 3_{A}, 3_{B}. Because a part of the “line-switched” transmission link is realized with a packet-switching network, the delay between the final points is no longer constant because the data packets can take different paths and are processed in the network elements (for example router) by queuing systems and therefore show different running times. The variability of the arrival time of the arriving data packets is balanced by a jitter buffer in the media gateways, a variable buffer size is thereby provided for the voice service. This is necessary in order to keep the delay as short as possible in the voice service, so that the buffer size can be adjusted dynamically to the instantaneous situation. Contrary to this, the delays are relatively uncritical for the voice service, i.e. fax or modem services in the speech tape on the one hand, but data losses are to be excluded as much as possible on the other hand. For this a fixed but higher buffer size is intended, hoping that there is still space in the buffer for each arriving packet. Because the media gateway controller doesn't generally receive any precise information regarding the type of the useful information (voice and in particular data in the speech tape) by the signalization, a presetting of the media gateways to voice (i.e. for example variable jitter buffer) takes place in these cases. Because of the above reasons, a change-over to a fixed buffer size occurs for the data communication. The change-over is initiated by a sound detector or a sound detection function 10 in the transmitting path of the media gateway 3B of the B-side (turned to the called subscriber/terminal). This occurs thereby with a messages to the media gateway controller, who then arranges for the media gateway on the A-side (turned to the calling subscriber/terminal) to change over the buffer size. But this change-over implicates the problem, that a phase jump and/or signal pause is thereby pretended in the signal to be transmitted. Like this, an echo canceller for example, can interpret the disabling sound for echo suppressing (2100 Hz continuous) as disabling sound for echo suppressing and echo cancellers (2100 Hz with phase jump) or a terminal can rate the signal pause in a signal as a transmission error. For the transmission procedures as QAM (Quadrature Amplitude Modulation) digital signals are disclosed by a combination of four phases and four amplitudes. A distortion by the change-over to a fixed buffer size leads to a necessary error or falsification of the transmitted information.

A method and an arrangement are disclosed in the document EP 0 577 269 B1 (AT&T Corp), where data packets with priority attributes are transmitted, typically with the ATM (Asynchronous Transfer Mode) method. Depending on a multiple number of evenly prioritized connections, the phenomenon of the jitter is also produced by this. To reduce this with real time applications as for example voice or video, a table is proposed, where, depending on the priority, an additional priority is indicated, to guarantee a relative “worst case jitter”.

For a transmission based on the internet protocol, the mechanism of the priority placing is only implemented with the version IP V6. In addition, this would not be applicable, because a significant signaling traffic concerning the priority allocation between the media gateway controller and the allocated media gateways would result from this and the jitter can also arise from different paths and levels of the queues. A possible prioritization with IPv4 (diffserv, intserv) only leads to a preferred treatment of the prioritized packets. This only helps if there are packets with different priorities.

### SUMMARY OF THE INVENTION

The present invention is therefore based on the task to indicate a method and a media gateway, which avoids the interference effect on simple and multi frequency signals, caused by a buffer storage manipulation during the change-over from voice to data in the speech tape.

According to the present method, where an additional sound detection function is provided for each connection in direction to the to the line switching network, which carries out a setting of the jitter buffer size by the control, depending on the determined service, a jitter buffer manipulation at the change-over from voice service to data service (in the speech tape) can be carried out in real time, without first causing an inference effect in the signal to be transmitted and second without initiation of this manipulation by the media gateway controller, which then could take place in real time.

i) Thereby, that the additional sound detection function indicates a disabling sound of an echo suppressing function, integrated in the media gateway, for the disconnection of an external echo suppressing, a quality impairment, caused by two activated echo suppressing functions (second echo suppressing function in modem) can be avoided in the transmission.

ii) Thereby, that the control carries out a pre-setting of the jitter buffer size for the data service in the speech tape, either by a media gateway controller or by the sound detection function in direction to the packet switching network, interferences in the exchange of information of the terminals in the beginning of a connection, independent from the actual determined service, can be excluded.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts network scenario with a packet switching backbone network;

FIG. 2 depicts modular mimic display of a media gateway according to the invention.

### DETAILED DESCRIPTION OF THE INVENTION

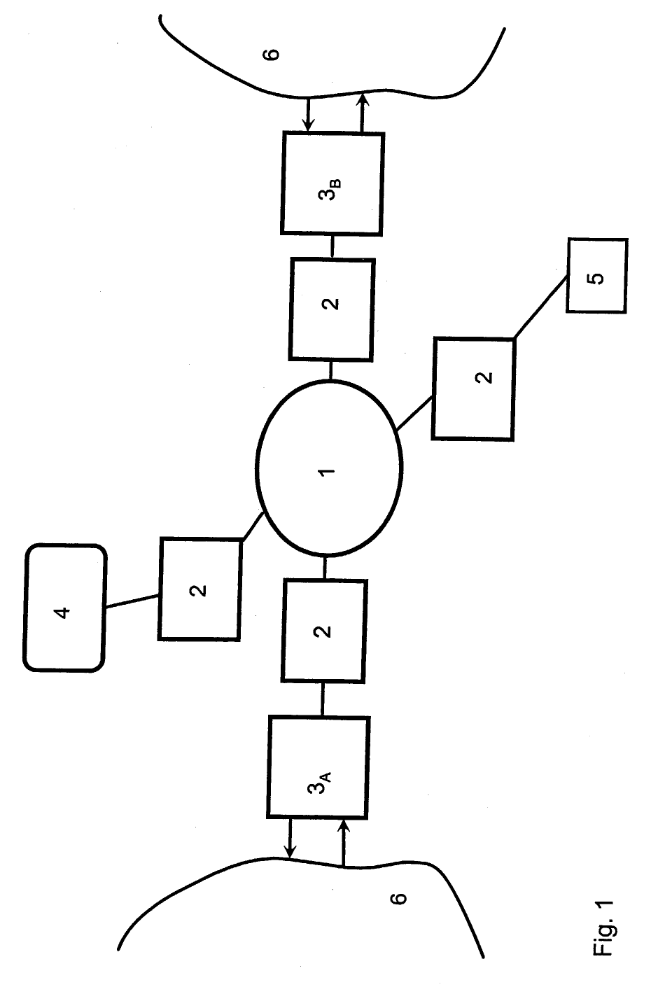

As already described, FIG. 1 shows a network scenario with a packet switching network 1 as a backbone of a line switching network and in particular connection network 6. The line-switching network 6 is described in the following with TDM or TDM network alternatively to the reference 6. It is thereby not visible for a subscriber at the TDM network, if, for a certain connection to another subscriber, a packet network 1 is inserted as transportation network and in particular as backbone networks in between. This packet network 1 can for example be carried out as ATM backbone network or as IP (over ATM) backbone network. It is assumed for the further explanation of the present invention, that subscriber A is located on the left side of FIG. 1. Accordingly, the media gateway on the side of subscriber A is provided with the reference 3_{A} and correspondingly on the side of subscriber B, the media gateway is marked with the reference 3_{B}. The directions of transmission are provided with arrows. The media gateways 3A, 3B are controlled by a common or two separate, associated media gateway controller(s) 4, in FIG. 1, the backbone network is composed of an edge router 2, which carries out an interface adaptation between the interface (for example Ethernet) of the media gateway and the media gateway controllers on the one hand and the interface of the core routers on the other hand, and of a number of core routers, symbolized as transportation network 1. The subscriber H.323 or SIP disclosed in FIG. 1 with the reference 5 can also be directly connected to the before-mentioned backbone network; an edge router 2 is not coercive.

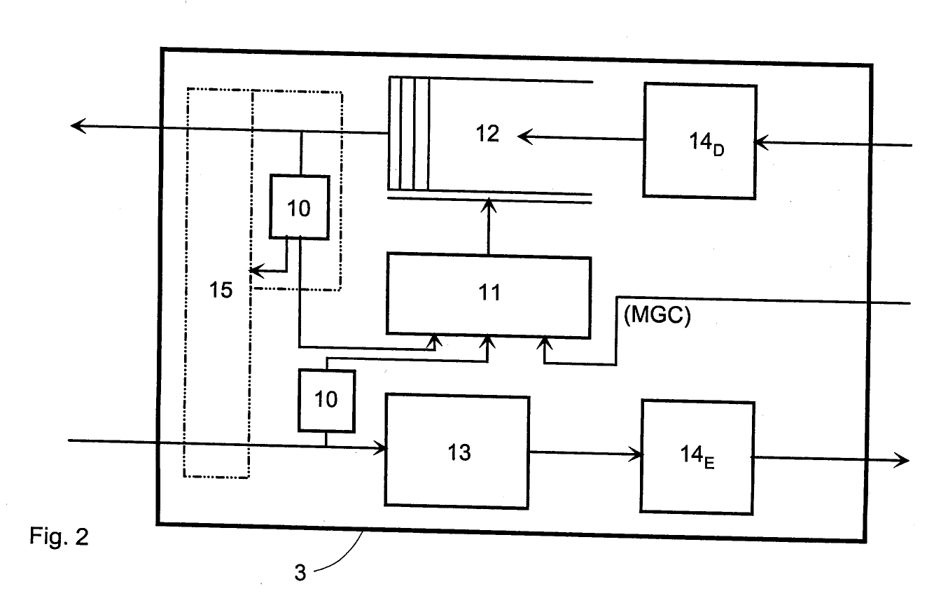

FIG. 2 shows a modular mimic display of a media gateway 3 according to the invention. The voice activity recognition 13 is provided for the optimal usage of the band width in the packet network 1. The real time protocol encoder 14E is thereto instructed to not send any utilization packets but a control packet with the content “comfort noise”, so that on the other side (A or B side) a corresponding signal as “pink-noise” is produced, so that the listener does not have the impression of an interrupted connection. The voice activity recognition produces such an information based on a permanent low level, for example <31 dBm0. It is assumed for the explanation, that the media gateway 3_{A} concerned is on the side of subscriber A. But the media gateways 3_{A} and 3_{B} are preferably realized with identical functions. A sound detector 10 is arranged in the media gateway 3A on the side TDM for connections originating from this side, which can distinguish between a fax or modem transmission and a voice communication based on a determined simple or multi frequency signal. Fax and modem services are sub summarized in the following under the term “data service” and in particular, where necessary, under the term “data service in the speech tape”. Based on this distinction, a setting of the jitter buffer size is carried out according to the state of art as follows.

Voice service:

Variable buffer size;

Data service in the speech tape:

Fixed, but relatively high buffer size.

It would also correspond to the state of the art, if the service-related setting of the jitter buffer size was arranged by the media gateway controller. This is disclosed in FIG. 2 with the connection MGC. Because the communication sometimes starts with a signal for fax/modem connections, which runs from A to B - although the connecting request was initiated by A—an additional sound detection function 10 needs to be provided, which is arranged in direction to the TDM. This additional sound detection function 10 in direction to the TDM network is preferably arranged to the jitter buffer in the following. Such a sound detection function 10 is now used according to the invention, to set the jitter buffer size in direction to the line-switching network and in particular connecting network dependant from the determined service. The setting itself occurs identical, as above described, to the voice service and in particular data service in the speech tape. Furthermore, the disabling sound is recognized too in an additional sound detection function 10 and displayed in an echo suppressor, additionally integrated in the media gateway 3. This echo suppressor 15, which is generically specified according to ITU-T Rec. G.164 as echo suppressor, shows echo compensation according to ITU-T Recs. G.165 or G.168. The function of the integrated sound disabler exists therein, to switch off the activated echo compensator 15 for the duration of a fax/modem connection based on a detected disabling sound. After completion of the above fax/modem connection, the echo suppressor function 15 returns to its original condition (enabled resp. disabled). The echo suppressor functions 15 can, depending on the implementation, be permanently allocated to the connections (slot times) or be allocated dynamically to the connections from a pool. The sound detection function 10 disclosed in FIG. 2 is implemented only once and is dynamically called several times with an own running time environment (process) each and an own stack according to the traffic volume. This allows a particularly advantageous design of the present invention, because a sound detection function 10 already exists in a media gateway.

The connection of the sound detection function 10 with a control 11 for the jitter buffer size sets it on a predetermined value by the sound detection function 10. The control 11 still enables the media gateway controller (compare reference MGC in FIG. 2) to set the jitter buffer size in direction to the TDM→packet network. This value should be selected big enough so that no packet loss, based on a jitter buffer size which is too small, takes place. A setting of the jitter buffer size in the direction to the packet network→TDM now occurs according to the invention based on a determined service in the speech tape according to the above mentioned direction. In detail, the following is intended for the two services:

1 Voice service

A minimal delay is unalterable for the voice service. The jitter is measured in the unit 14_{D} for this and, compared to found packet losses; a minimal jitter buffer size is preset. On the same layer, the unit 14_{D} comprises the function real time transport protocol RTP together with real time control protocol RTCP. The unit 14D offers services such as packet loss detection, identification of the content of the packets, arrangement of arriving packets in the originally sent sequence. Voice signal are mostly stationary when looked at in small units of time.

2 Data Service in the speech tape

The delay in the speech tape is less critical than a packet loss for the data service, among other because of the burst-like data traffic. The consequence of this is that the sound feature should be influenced by this as little as possible. Accordingly, the sound detection function 10 needs to be able to detect possible occurring phase jumps in a sound signal of even frequency (for example 2100 Hz with or without phase jump). If the sound detection function 10 in direction to the TDM→packet network 1 detects a fax/modem service in the speech tape, the jitter buffer in direction to the packet network 1→TDM is set to the initially mentioned big enough fixed value. This allows for the sound detection function 10 in direction to the packet network 1→TDM to detect all sounds and to correctly carry out the indication for the disabling sound of the echo suppressing function 15.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

I claim:

1. A method for the setting of the jitter buffer size in a media gateway inserted between a line-switching and a packet-switching network, whereby voice and data services are controlled in the speech tape by the media gateway and the media gateway shows a jitter buffer and a sound detection function which carries out the setting of the jitter buffer size with a control for each connection in direction to the packet-switching network, comprising the steps of: providing additional sound detection function for each connection in direction to the line-switching network, which, depending from the determined service, carries out a setting of the jitter buffer size by the control.

2. The method according to claim 1, wherein the additional sound detection function indicates a disabling sound of an echo suppressing function integrated in a media gateway.

3. The method according to claim 1, wherein the additional sound detection function sets up a variable jitter buffer size for the voice service and a fixed one for the fax/modem service.

4. The method according to one of the claim 1, wherein the control carries out a presetting of the jitter buffer size for the data service in the speech tape either by a media gateway controller or by the sound detection function in direction to the packet-switching network.

5. The method according to claim 1, wherein the additional sound detection function is arranged between the jitter buffer and the line-switching network.

6. The method according to claim 5, wherein a real time protocol decoder is superposed to the jitter buffer on the side of the packet-switching network, where the jitter is measured and a minimal jitter buffer size is preset compared to the determined packet losses.
